(19) United States
(12) Patent Application Publication
(10) Pub. No.: US 2005/0079257 A1
(43) Pub. Date: Apr. 14, 2005

(54) Method to obtain a food product for immediate consumption or to be prepared later provided with marks or engravings made on the external surface of the food product and food product with marked surface

(76) Inventor: Jose Barbosa Machado Neto, Sao Paulo (BR)

Correspondence Address: NOTARO AND MICHALOS, 100 DUTCH HILL ROAD, SUITE 110, ORANGEBURG, NY, 10962-2100, US

(21) Appl. No.: 10/686,289

(22) Filed: Oct. 15, 2003

(30) Foreign Application Priority Data
Oct. 10, 2003 (BR) PI0303052-0

(51) Int. Cl. A23P 1/00

(52) U.S. Cl. 426/383

(57) ABSTRACT

A method to obtain a food product for immediate consumption or to be prepared later, provided with marks or engravings made on the external surface of the food product and food product with marked surface, more specifically dealing with a method (1) to obtain a food product (2) for immediate consumption or to be prepared later, in which said product (2) is provided with marks or engravings (3) made by a calorie-producing equipment (4) over at least one of the external surfaces of said food product (2), being said marks or engravings electronically and remotely pre-programmed on a PLC (P); said marks (3) are made so that the indications (5) (logo, date of production, expiry, batch, etc.) are recognized visually and by touch on the surface(s) of said product (2), be it within its pack (6) or exposed for consumption.

### DISCLOSURE OF THE INVENTION

The present invention refers to a method to obtain a food product for immediate consumption or to be prepared later, provided with marks or engravings made on the external surface of the food product and food product with engraved surface, more particularly referring to a method to prepare food products, preferably meats of any kind, quality and presentation, which then have, on at least one of their external surfaces, marks which can be recognized visually and/or by touch, since said marks are obtained by means of processes using calorie-producing devices, such as hyper-heated metal heads, laser or any other equivalent means.

As known by both consumers and food product manufacturers in general, the existence of the most wide ranges of graphical indications on the product to be commercialized, such as logotype, origin, production batch, date of expiry, etc., is a mandatory condition, being said indications mostly applied to the packing of the product to be consumed or even by means of stamps, paper enclosures, plastics or other appropriate means.

Producers are much worried to develop packs or enclosures which can be kept next to the product for as long as possible, so to make the product trademark to remain shown for longer, but also to keep all pertinent product information next to it for longer, thus assuring consumer trustfulness.

This not only occurs with immediate consumption product, such as sausages and similar, but also in the case of products to be prepared later.

In the case of sausages or the like, packs are usually made of multiple-layer plastics, especially developed to protect the product from light rays and also from the paint from graphical printing.

In the case of products sold as “ready dishes”, which are already seasoned and cooked/baked/fried, these are wrapped up in packs developed under the highest conservation and sterilization standards, which may or not be kept under refrigeration, also allowing their heating by microwave and general ovens.

Another model known by the general public are edible articles, particularly meats and similar, which are yet in raw state and supplied under seals fastened onto the product itself, so to show its origin, performing the task of a certifying element; said seals must be taken off the product before the food is prepared, since they are made of plastic and not resistant to heating.

Despite all the developments performed by the packing industries, it is known that, once the product is taken off its respective conditioning package, be it for immediate consumption, be it to be prepared over appropriate supports, it starts to be exposed with no origin identification, i.e., once taken off the package it is no longer possible to identify its producer, nor its expiry and batch indications, etc., which can cause great trouble in case of refusals or returns by consumers or even distributors.

The above-described fact is usual and thus most consumers, distributors and manufacturers do not see the problem.

To understand the existing problem, a hypothetical and usual situation existing in the commercial circuit is described below: the producer of a given edible article, attempting to meet both the laws and the final consumer, presents its product wrapped up in a pack with high quality standards, appropriately and with full graphic indications printed on the external faces of the pack. Said product is sent to the distributor, who keeps it appropriately stored under all conservation rules. Once exposed on the distributor's shelf or refrigerator, the product is purchased by the consumer who, to prepare it for consumption, take it from its disposable pack or simply take off the cap of the pack (where graphic indications are usually found, such as trays for ready products), taking it to the microwave or other conventional oven.

In the event of any problem with the product for which the consumer needs to reject it at the start of the consumption, it becomes difficult to identify the reason, since there is no longer how to claim to the distributor and consequently to the manufacturer, since all information was discharged.

The result of this hypothetical but common situation is consumer's loss and the consequent loss of trustfulness for distributors and manufacturers.

On the other hand, if any of the last two interested parties had been informed, consumer's loss could not only be reimbursed, but also the returned product would be forwarded to identify the problem causing its rejection by the consumer, i.e. it would be verified if the product was damaged due to packing problems or even as a consequence of its manufacturing and preparation process, and many procedures could thus be corrected if there were identification over the rejected product.

As a consequence of the above, and especially due to the current needs of the market over the so far existing state of the art, the applicant developed a method to obtain a food article for immediate consumption or to be prepared later, provided with marks or engravings made on the external surface of the food article and marked article over at least one of the surfaces, being more particularly a method to mark visual and touch indications over the surfaces of meats in general, which main purpose is to make the product offered for immediate consumption or to be prepared by cooking or frying to be provided with marks to be recognized at any time, be it inside the pack or during consumption.

The method detailed below is applied over slices, pieces or milled portions of already prepared meat (bovine, swine, poultry, fish and others), i.e. in raw, cooked or baked state, be it seasoned or not, and, by means of calorie-producing equipment such as laser, hyper-heated metal heads, etc., engravings are made over at least one of the external surfaces of said food articles; said printings or marks are pre-programmed electronically and remotely on a PLC.

Therefore, the food article, when already produced and engraved by the innovative method, is forwarded to a packing stage, being wrapped up in various packs, such as trays, pouches and others, and from there it is forwarded for distribution and supply to the consumer market, needing refrigeration or not.

Thus, in case of a rejection by the consumer at the time of consumption, he or she can wrap up the product in any pack and take it to the distributor where it was purchased, or even contact the producer to be reimbursed, consequently causing all the chain round, i.e. to find out the problem causing said rejection. This can be extended to restaurants and similar, since all printings can be found on the product to be consumed.

The method presented herewith, besides allowing this procedure between producer/distributor and consumer to happen, strengthens the main sale argument for the product, i.e. the trust for the trademark, since it is shown as printed on the product up to the end of its consumption.

To complement the present description so to obtain a better understanding of its features and according to a preferential practical embodiment, the description is followed by an attached set of figures, in which the following was represented as examples but in a non-limitative purpose:

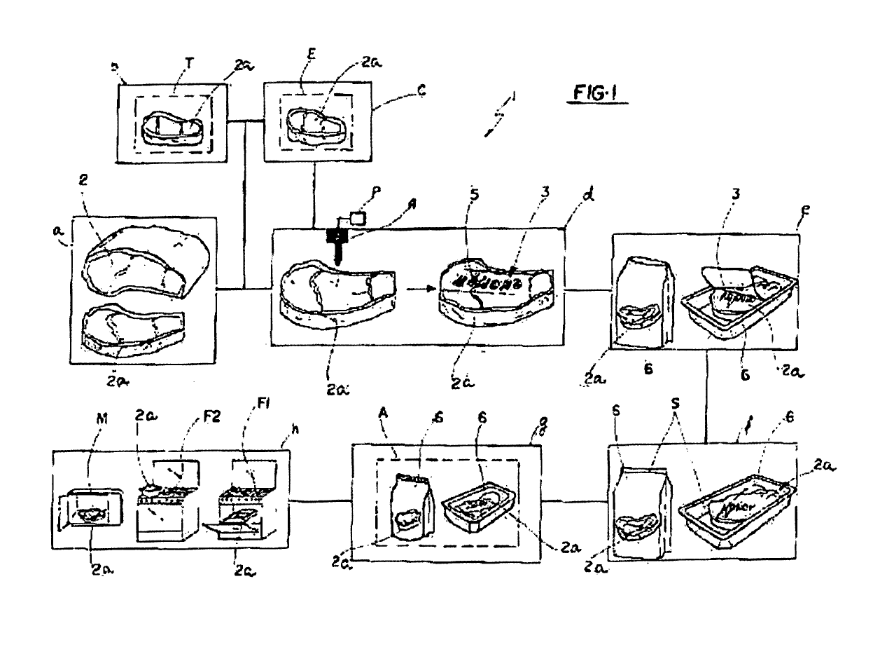

FIG. 1 shows the method represented by means of a block diagram with illustrations to improve its understanding.

Concerning the accompanying figures, the present invention refers to a “METHOD TO OBTAIN A FOOD PRODUCT FOR IMMEDIATE CONSUMPTION OR TO BE PREPARED LATER, PROVIDED WITH MARKS OR ENGRAVINGS MADE ON THE EXTERNAL SURFACE OF THE FOOD PRODUCT AND FOOD PRODUCT WITH MARKED SURFACE”, more specifically dealing with a method (1) to obtain a food product (2) for immediate consumption or to be prepared later, preferably articles such as meat slices, pieces or agglomerates (bovine, swine, poultry, fish and others), provided with marks or engravings (3) on at least one of its external surfaces, made by a calorie-producing equipment (4); said marks are electronically and remotely pre-programmed on a PLC (P); said marks are made so that the indications (5) (logo, date of production, expiry, batch, etc.) are recognized visually and/or by touch on the external surface(s) of said article (2), be it within its pack (6) or exposed for consumption.

The method (1) to be obtained follows the stages below:
the food product (2) (bovine, swine, poultry, fish and other meats, such as pieces of tenderloin, rump, loin, sirloin, chicken breast, hamburger, meatballs, etc.) is shaped into slices and/or pieces (2a) and said article may be refrigerated and/or frozen, with the thickness of said slices and/or pieces (2a), as well as their weight as previously determined, depending on their intended purpose;
after being cut, said slices and/or pieces (2a) may be seasoned (T) or not; (the time for which said slices and/or pieces remain within the seasoning, in case of the option for seasoning, would also be determined according to the requirements, and there would still be the option to season the meats while still raw, refrigerated and/or frozen, besides the ingredients to be used, which are defined according to the requirements or the flavor intended to be produced);
such frozen and/or refrigerated pieces and/or slices (2a) are then put into devices (E) to cook, grill and/or bake them, with the time and temperature under which they will be cooked, grilled and/or baked depending on various factors, such as: type of the meat; thickness of the piece or slice; if it was refrigerated or frozen; the requirement for a product to be well-done or underdone; commercial purpose; among others.

After the article (2) is cooked, grilled and/or baked, pieces and/or slices (2a) of the articles (2) are engraved (3) by means of a calorie-producing equipment (4) (hot printing (with heated head); laser printing; other equivalents producing calories meeting the definition requirements for printing, printing tones, shapes, statements, figures, information, etc.) remotely controlled by PLC (P), in which said printings may be constituted of the following identifying elements (5): grilling marks; company logo; production batch number; figures or messages to be defined, depending on market or customer needs; among others.

After the meat has passed through stage “c” and has been baked, cooked or grilled and duly printed (3) in stage “d”, it is wrapped up in a pack (6) such as a plastic and/or aluminum tray, pouches or others which are hermetically sealed, which packs can be rigid and/or flexible, depending on customer and/or market requirements; packs may or not contain divisions for the inclusion of sauces, vegetables, etc., depending on customer needs; at the time of packing, the following methods can be used, among others: vacuum; inert gas; modified atmosphere; nitrogen, etc.; the product can be introduced in the packs manually and/or automatically;
the pack is hermetically sealed (S) just after the article (2a) has been introduced; after sealing, the pack is sterilized in an autoclave equipment (A), (this equipment has the purpose to, by means of thermal treatment, sterilize the article inside the packs, even if these packs are hermetically sealed, thus assuring product sterilization while it remains within the closed pack); after sterilization, the article (2a) becomes stable at room temperature, keeping its features for up to 36 months, with no need for refrigeration; packs can therefore be stored, transported and commercialized inside the packs with no need to keep them under refrigeration;
the article (2a) (seasoned, prepared, marked and packed) is ready for consumption and can be heated in various ways, as follows:
microwave (M): packs are ready to be taken directly to the microwave to be heated; and
electric or gas oven (F1): in this case, the product should be taken from its original pack and heated as most convenient; stove (F2); in this case, the product should also be taken from its pack to be heated as most conveniently for consumers.

Although the present invention is detailed, it is important to understand that the present application is not limited to the details and stages as described herewith. The present invention allows other modes and can be practiced or executed in a variety of modes. It should be understood that the terms used herein are for the purpose of description and not limitation.

1. A method to obtain a food product for immediate consumption or to be prepared later, provided with marks or engravings made on the external surface of the food product and food product with marked surface, more specifically dealing with a method (1) to obtain a food product (2) for immediate consumption or to be prepared later, in which said product (2) is provided with marks or engravings (3) made by a calorie-producing equipment (4) over at least one of the external surfaces of said food product (2), being said marks (3) electronically and remotely pre-programmed on a PLC (P); said marks (3) are made so that the indications (5) (logo, date of production, expiry, batch, etc.) are recognized visually and/or by touch on the external surface(s) of said product (2), be it within its pack (5) or exposed for consumption.

2. The method of claim 1, in which the method (1) comprises the following stages:
(a) the product (2) is cut into slices and/or pieces (2a) and it may be refrigerated and/or frozen, with the thickness of said slices and/or pieces, as well as their weight as previously determined, depending on their intended purpose;
(b) after being cut, said slices and/or pieces (2a) may be seasoned (T) or not (the time for which said slices and/or pieces remain within the seasoning, in case of the option for seasoning, would also be determined according to the requirements, and there would still be the option to season the meats while still raw, refrigerated and/or frozen, besides the ingredients to be used, which are defined according to the requirements or the flavor intended to be produced);
(c) such frozen and/or refrigerated pieces and/or slices (2a) are then put into devices (E) to cook, grill and/or bake, with the time and temperature under which they will be cooked, grilled and/or baked depending on various factors, such as: type of the meat; thickness of the piece or slice; if it was refrigerated or frozen; the requirement for a product to be well-done or underdone; commercial purpose; among others;
(d) after the article (2) is cooked, grilled and/or baked, pieces and/or slices (2a) of the articles (2) are engraved (3) by means of a calorie-producing equipment (4) remotely controlled by a PLC (P), which engravings may be constituted of the following identifying elements (5): grilling marks; company logo; production batch number; figures or messages to be defined, depending on market or customer needs; among others;
(e) after the meat has passed through stage “c” and has been baked, cooked or grilled and duly engraved (3) in stage “d”, it is wrapped up in a pack (6) such as a plastic and/or aluminum tray or pouches, which packs can be rigid and/or flexible; packs may or not contain divisions for the inclusion of sauces, vegetables, etc.; at the time of packing, the following methods can be used, among others: vacuum; inert gas; modified atmosphere; nitrogen, etc.; the product can be introduced in the packs manually and/or automatically;
(f) the pack is hermetically sealed (S) just after the article (2a) has been introduced;
(g) after sealing, the pack is sterilized in an autoclave equipment (A), making the article (2a) become stable at room temperature, keeping its features for up to 36 months, with no need for refrigeration; and
(h) the article (2a) (seasoned, prepared, marked and packed) is ready for consumption and can be heated by the microwave oven (M), electric or gas oven (F1), stove (F2) or others.

3. The method according to claim 1, in which the marks (3) of the identifiers (5) as made over the faces of the article (2a) are obtained by means of calorie-producing equipment (4) for printing by means of a hyper-heated metal head.

4. The method according to claim 1, in which the marks (3) of the identifiers (5) as made over the faces of the article (2a) are obtained by means of calorie-producing equipment (4) for laser printing.

5. The method according to claims 1, in which the marks (3) of the identifiers (5) as made over the faces of the article (2a) are obtained by means of calorie-producing equipment (4) meeting the requirements for printing definition, printing tones, shapes, statements, figures, information, etc.

6. A food product with marked external surface made according to claim 1, in which the product (2) is constituted by slices, pieces or milled portions (2a) of bovine, swine, poultry, fish meat and others.

7. The food product with marked external surface made according to claim 1, in which the product (2) presents marks (3) produced by heating and in low relief made over at least one of the external surfaces.
